(19) United States
(12) Patent Application Publication
(10) Pub. No.: US 2005/0286733 A1
(43) Pub. Date: Dec. 29, 2005

(54) Integrated loudspeaker and acoustic treatment system

(76) Inventor: Anthony Grimani, Fairfax, CA (US)

Correspondence Address: JOHNSON & STAINBROOK, LLP, 3558 ROUND BARN BLVD., SUITE 203, SANTA ROSA, CA, 95403, US

(21) Appl. No.: 11/169,129

(22) Filed: Jun. 27, 2005

Related U.S. Application Data
(60) Provisional application No. 60/583,963, filed on Jun. 28, 2004.

(51) Int. Cl. H04R 1/02; H04R 5/02

(52) U.S. Cl. 381/333; 381/301; 181/198; 381/87

(57) ABSTRACT

A loudspeaker and acoustic treatment system including at least one loudspeaker physically incorporated into at least one acoustic treatment panel, and dispersion pattern control means preset in a standard configuration.

### CROSS REFERENCE TO RELATED APPLICATIONS

The present application claims the benefit of the filing date of U.S. Provisional Patent Application, Ser. No. 60/583,963, filed Jun. 28, 2004 (Jun. 28, 2004).

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to acoustic devices, more particularly to an integrated loudspeaker and acoustic treatment unit.

### BACKGROUND INFORMATION AND DISCUSSION OF RELATED ART

A properly implemented audio media monitoring or playback system in a commercial or residential space has two primary aspects. The is the actual sound reproduction equipment. Such equipment includes source components, preamplifiers, sound mixing consoles, amplifiers, and loudspeakers. The second is the acoustic treatment materials that are used to control the sound after it has been reproduced by the equipment.

In current applications, these two aspects of sound reproduction systems are dealt with separately in physically discrete components. A system of electronic devices is assembled to produce sound, and a system of acoustic materials is assembled to control the sound in the space, most often in the form of acoustic treatment panels that provide vibration isolation, absorption, diffusion, and damping. A conflict often develops between the two systems, as elements of one system frequently need to be in the same physical location as elements of the other system. For example, a loudspeaker and a sound absorption panel might need to be colocated for each to function optimally. Further, positioning of both electronics and acoustic materials in a room generally leads to an unappealing aesthetic appearance that is either impractical or extremely expensive to remedy without detracting from the performance of the sound reproduction system.

Accordingly, it would be desirable to colocate audio loudspeakers in acoustic treatment materials. While it is known to colocate certain electronic elements or components of audio systems, there are no known references showing a combined loudspeaker and acoustic treatment system, and nothing known to the present inventor discloses, teaches, suggests, shows, or otherwise renders obvious, the invention described and claimed herein.

### BRIEF SUMMARY OF THE INVENTION

The present invention solves the above-described problems by integrating loudspeakers into acoustic treatment units. The combined loudspeaker/acoustic treatment unit is then covered with an acoustically transparent finishing layer that transforms the unit into an aesthetically pleasing element. The finishing layer takes the form of plain, acoustically transparent fabric, or some other surface, fabric or otherwise, onto which may be printed or stenciled artistic decorations (such as paintings, photographs, designs, posters, etc.). The final product is placed around a space, both producing and controlling the sound in that space.

It is therefore an object of the present invention to provide a new and improved integrated loudspeaker and acoustic treatment unit.

It is another object of the present invention to colocate a loudspeaker with an acoustic treatment unit and cover the combined unit with an acoustically transparent finishing layer.

A further object or feature of the present invention is to provide an integrated loudspeaker and acoustic treatment system that reduces the space required to achieve optimal acoustic performance in a selected sound system.

A still further object of the present invention is to provide an inexpensive combined loudspeaker and acoustic treatment panel that facilitates the creation and installation of an aesthetically pleasing arrangement of acoustic components in residential and commercial settings.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is perspective view of a first preferred embodiment of the integrated loudspeaker and acoustic treatment system of the present invention; and

FIG. 2 is a perspective view showing a second preferred embodiment of the inventive integrated loudspeaker and acoustic treatment system.

### DETAILED DESCRIPTION OF THE INVENTION

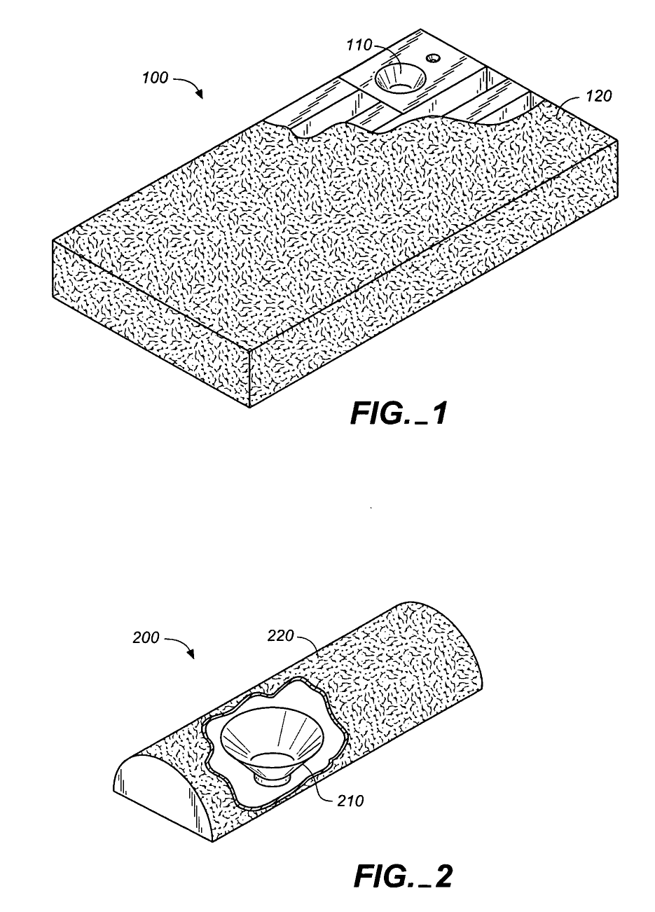

Exemplary and preferred embodiments of the inventive integrated loudspeaker and acoustic treatment system of the present invention are shown in FIGS. 1 and 2. FIG. 1 is perspective view of a first preferred embodiment 100 showing the combined unit comprising a two-way loudspeaker 110 incorporated into an acoustic treatment panel 120, which panel may provide vibration isolation, absorption, diffusion, and/or damping, or some combination thereof.

FIG. 2 illustrates a second preferred embodiment 200 showing the integrated loudspeaker and acoustic treatment system comprising a subwoofer 210 incorporated into a cylindrical acoustic treatment panel 220. Again, the acoustic treatment panel may provide vibration isolation, absorption, diffusion, damping, and/or some combination thereof.

In each of the first two preferred embodiments, the unit is covered by an acoustically transparent finishing layer, preferably comprising plain, acoustically transparent fabric, in a manner well known in the art.

The essential device takes the form of a loudspeaker mounted in or on an absorber or diffuser panel, either in the center of the panel, or, depending on intended use of the panel, to one side of the panel or in a corner of the panel. The loudspeaker cabinet may either be a self-contained unit that is only attached to the panel, or it may be integrated into the physical structure of the panel itself, as shown in the figures. The architectural design, shape, and construction of the panel may be varied to support the cubic volumes required by the cabinets of different types of loudspeakers (including full range, limited-bandwidth, and subwoofer loudspeakers) and also to provide a pleasing aesthetic look if the panels are placed next to each other on walls or ceilings.

If control of the dispersion pattern of the loudspeaker is required, two panels may be placed next to each other with integrated speakers proximate the adjoining edges. Control of the exact dispersion of this newly-formed loudspeaker system pair may be accomplished in one of two ways. The first is through an external device (either attached to the panels or remote) that alters the polarity, phase, and/or volume level of the two loudspeakers so that they combine to form a dispersion pattern that is different from their individual dispersion patterns or the dispersion pattern created by simply placing the two loudspeakers next to each other. The second way to control dispersion is to provide controls that adjust polarity and volume level into the loudspeakers themselves rather than an external device. With these general approaches in view, the means for accomplishing these objectives are well known. Regardless of the location of the controls, they may be preset for any number of so-called standard configurations, in addition to providing variable parameters for purely custom applications. Standard configurations would include Single Point Source Monopole (only one loudspeaker produces sounds), Dual Point Source Bipole (both loudspeakers produce sound in the same polarity), and Dual Point Source Dipole (the two loudspeakers produce sound in opposite polarities).

The inventive combination loudspeaker/acoustic treatment unit may be used for home theaters, media rooms, recording studios, project studios, boardrooms, classrooms, and other applications where sound production and control in an aesthetically pleasing package are required.

Accordingly, in one aspect, the inventive loudspeaker and acoustic treatment system may be seen to comprise at least one loudspeaker physically incorporated into at least one acoustic treatment panel. Additionally, the system may include some means for controlling the dispersion pattern of the loudspeaker sound. This may comprise at least one pair of integrated loudspeakers and acoustic treatment panels, each including a loudspeaker physically incorporated into an acoustic treatment panel, wherein each of the loudspeakers is positioned proximate the adjoining edges of the acoustic treatment panel in which it is housed, and either and integrated or an external device in electronic communication with the loudspeakers that alters the polarity, phase, and/or volume level of the loudspeakers. The control device may be pre-set in a standard configuration, as described above.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

1. A loudspeaker and acoustic treatment system comprising at least one loudspeaker physically incorporated into at least one acoustic treatment panel.

2. The system of claim 1, wherein each of said at least one acoustic treatment panels is selected from the group consisting of acoustic vibration isolators, acoustic absorbers, acoustic diffusers, acoustic vibration dampers, and any combination thereof.

3. The system of claim 1, further including dispersion pattern control means for controlling the dispersion pattern of loudspeaker sound.

4. The system of claim 3, wherein said dispersion pattern control means comprises:
at least one pair of integrated loudspeakers and acoustic treatment apparatus, each comprising a loudspeaker physically incorporated into an acoustic treatment panel, wherein each of said loudspeakers is positioned proximate the adjoining edges of its respective acoustic treatment panel; and
an external device in electronic communication with said loudspeakers that alters the polarity, phase, and/or volume level of said loudspeakers such that they combine to form a dispersion pattern different from their individual dispersion patterns and/or the dispersion pattern created when said loudspeakers are placed next to each other.

5. The system of claim 4, wherein said dispersion pattern control means are pre-set in a standard configuration selected from the group consisting of single point source monopole, dual point source bipole, and dual point source dipole.

6. The system of claim 3, wherein said dispersion pattern control means comprises:
at least one pair of integrated loudspeakers and acoustic treatment apparatus, each comprising a loudspeaker physically incorporated into an acoustic treatment panel, wherein each of said loudspeakers is positioned proximate the adjoining edges of its respective acoustic treatment panel; and
controls integrated into said apparatus that adjust the polarity and volume level of said loudspeakers.

7. The system of claim 7, wherein said dispersion pattern control means are pre-set in a standard configuration selected from the group consisting of single point source monopole, dual point source bipole, and dual point source dipole.
